(19) United States
(12) Patent Application Publication
(10) Pub. No.: US 2008/0012453 A1
(43) Pub. Date: Jan. 17, 2008

(54) MOTOR HAVING A HOLLOW DRIVE SHAFT

(75) Inventor: A.L. PEPPER AASGAARD, OMAHA, NE (US)

Correspondence Address: MCKEE, VOORHEES & SEASE, P.L.C., 801 GRAND AVENUE, SUITE 3200, DES MOINES, IA, 50309-2721, US

(73) Assignee: ABEO, LLC, Omaha, NE (US)

(21) Appl. No.: 11/779,123

(22) Filed: Jul. 17, 2007

Related U.S. Application Data
(60) Provisional application No. 60/831,366, filed on Jul. 17, 2006.

(51) Int. Cl. H02K 7/10

(52) U.S. Cl. 310/75 R; 29/243.523

(57) ABSTRACT

A motor assembly for use in a inline device is disclosed. The motor assembly has a motor for operating the inline device. A hollow drive shaft passes through the motor to provide a conduit which an expendable portion of some fixturing hardware used with the inline device passes through to eject from or collect within the inline device. In another embodiment, the motor assembly is adapted for use in a tool for setting self-tapping rivets. The motor assembly has a motor having a hollow drive shaft adapted to pass through the motor and impart movement to a mandrel of the self-tapping rivet. A conduit within the hollow drive shaft is inline with the motor and is adapted to transfer the mandrel from one end of the tool, through the motor and into a repository upon detachment of the shank from the self-tapping rivet.

### CROSS-REFERENCE TO RELATED APPLICATIONS

This application claims priority under 35 U.S.C. § 119 to provisional application Ser. No. 60/831,366 filed Jul. 17, 2006, herein incorporated by reference in its entirety.

### FIELD OF THE INVENTION

The present invention generally relates to the field of motors, and more particularly to a hollow drive shaft for a motor, such as a pneumatic motor, an electric motor, or the like adapted for use in driving or operating any inline device.

### BACKGROUND OF THE INVENTION

Traditional motors, whether pneumatic, hydraulic, hydro or electrically driven, have a central drive shaft, which is typically inline with the motor to facilitate efficient transfer of rotational motion from the motor to the central drive shaft. For example, many inline devices use a central drive shaft, coaxial with the center of the motor, to drive a working implement associated with the inline device. Although this design represents the most efficient and cost effective means of transferring rotational motion to the working end of the inline device, they do not facilitate quick dispatch of spent portions of fixturing hardware associated with various tasks for which the inline device is used. For example, U.S. Pat. No. 6,796,759, issued Sep. 28, 2004, discloses a self-tapping rivet having a mandrel adapted for rotation by a central drive shaft of a motor wherein the mandrel detaches from the rivet upon setting the rivet in a work piece. The detached mandrel or spent portion must be dispatched from the working end of the rivet gun in the same manner it was inserted. The need to continually dispatch spent portions of fixturing hardware or other materials from the working end of an inline device represents a significant inefficiency. Therefore, there is a need to provide a motor having a hollow drive shaft to facilitate transfer of spent, residuary, or expendable portions of fixturing hardware or other materials through the drive shaft and motor to be ejected from the inline device or received within a repository adapted to capture the spent portions.

### BRIEF SUMMARY OF THE INVENTION

Therefore it is a primary object, feature, or advantage of the present invention to improve over the state of the art.

It is a further object, feature, or advantage of the present invention to provide a motor having a hollow drive shaft adapted to pass through the entirety of the motor.

Yet another object, feature, or advantage of the present invention is to provide a stationary inner tube within the hollow drive shaft wherein the stationary inner tube is adapted to transfer spent portions of fixturing hardware from the working end of an inline device, through the motor and into a repository adapted to collect the spent portions.

Still a further object, feature, or advantage of the present invention is to provide a hollow rotating internal armature that has grooves to promote the expulsion of spent portions.

Another object, feature, or advantage of the present invention is to provide a fixed and/or a rotating inner hollow armature or the like adapted that may be stationary or rotate with respect to the motor.

A still further object, feature, or advantage of the present invention is to provide a motor having a hollow drive shaft adapted to expel spent portions of hardware used in conjunction with an inline device.

A further object, feature, or advantage of the present invention is to provide a plurality of grooves extending spirally along an inner circumference of the hollow inner tube or hollow drive shaft to promote transfer of spent portions through the motor into the repository.

Yet another object, feature, or advantage of the present invention is to provide a motor having a hollow drive shaft that is pneumatically, electrically, hydraulically or hydro driven.

A still further object, feature, or advantage of the present invention is to provide a motor having a hollow drive shaft adapted to impart rotation to a self-tapping rivet and transfer a detached mandrel from the rivet through the hollow inner tube or hollow drive shaft and motor into a repository adapted to collect spent mandrels.

One or more of these and/or other objects, features, or advantages of the present invention will become apparent from the specification and claims that follow.

According to one aspect of the present invention, a motor assembly adapted for use in an inline device is disclosed. The motor assembly includes a motor adapted to impart movement to operate the inline device and a hollow drive shaft of the motor adapted to pass through the motor to provide a conduit through which an expendable portion of some fixturing hardware used with the inline device passes through to eject from or collect within the inline device.

A further aspect of the present invention includes the motor being pneumatically, electrically, hydraulically or hydro driven.

A further aspect of the present invention includes the hollow drive shaft surrounding a hollow inner tube adapted to expel the expendable portion of some fixturing hardware through the motor.

A further aspect of the present invention includes needle bearings or other bearings adapted to support rotation are disposed between the hollow inner tube and the hollow drive shaft to rotatably support the hollow drive shaft.

A further aspect of the present invention includes a plurality of grooves extending spirally along an inner circumference of the hollow drive shaft to promote transfer of the expendable portion of some fixturing hardware through the motor.

A further aspect of the present invention includes the expendable portion of some fixturing hardware being a shank of a self-tapping rivet.

A further aspect of the present invention includes a repository adapted to receive and collect the expendable portion of some fixturing hardware passed through the motor.

A further aspect of the present invention includes the repository being co-axial with the hollow drive shaft of the motor to facilitate transfer of the expendable portion of some fixturing hardware through the motor.

A further aspect of the present invention includes the repository having a deflector member adapted to direct travel of the expendable portion of some fixturing hardware expelled from the motor into the repository.

A further aspect of the present invention includes a plurality of grooves extending spirally along an inner circumference of the hollow inner tube to promote transfer of the expendable portion of some fixturing hardware through the motor.

A further aspect of the present invention includes the hollow inner tube being rotated with respect to the inline device to promote transfer of the expendable portion of some fixturing hardware through the motor.

A further aspect of the present invention includes vacuum being is used to promote transfer of the expendable portion of some fixturing hardware through the motor.

A further aspect of the present invention includes a plurality of ridges extending spirally along an inner circumference of the hollow drive shaft to promote transfer of the expendable portion of some fixturing hardware through the motor.

In another aspect of the present invention, a motor assembly adapted for use in an inline device is disclosed. The motor assembly includes a motor having a hollow drive shaft adapted to pass through the motor and impart movement to operate the inline device and a hollow inner tube within the hollow drive shaft adapted to provide a conduit through the motor wherein spent portions of fixturing hardware used with the inline device pass through to eject from or collect within a repository.

A further aspect of the present invention may include the hollow inner tube being stationary or rotational with respect to the inline device.

A further aspect of the present invention includes the hollow drive shaft rotating around the hollow inner tube to impart movement to operate the inline device.

A further aspect of the present invention includes needle bearings or other bearings adapted to support rotation are disposed between the hollow inner tube and the hollow drive shaft to rotatably support the hollow drive shaft and/or hollow inner tube.

A further aspect of the present invention includes a plurality of grooves extending spirally along an inner circumference of the hollow inner tube to promote transfer of spent portions through the motor upon rotation into the repository.

In a further aspect of the present invention, a motor assembly adapted for use in a hand tool to set a self-tapping rivet is disclosed. The motor assembly includes a motor having a hollow drive shaft adapted to pass through the motor and impart movement to a mandrel of the self-tapping rivet relative to the hand tool and a conduit within the hollow drive shaft wherein the conduit is inline with the motor and adapted to transfer the mandrel from one end of the tool body, through the motor and into a repository upon detachment of the shank from the self-tapping rivet. In the preferred form, the conduit is a stationary hollow inner tube disjunct from the hollow drive shaft.

In another aspect of the present invention, a rivet setting tool having a motor assembly adapted to pass a mandrel of a self-tapping rivet there through is disclosed. The rivet setting tool includes a tool body, an outer drive having a clutch adapted to grip and rotate the self-tapping rivet with respect to the tool body, a motor within the tool body having a hollow drive shaft, wherein the hollow drive shaft is configured to impart rotation to the outer drive, and a retraction assembly having a grip adapted to retract the mandrel wherein the retraction assembly operating separately from the outer drive to detach the mandrel from the self-tapping rivet wherein the hollow drive shaft of the motor adapted to pass through the motor to provide a conduit which the mandrel passes through to eject from or collect within the tool body.

A further aspect of the present invention includes the hollow drive shaft surrounding a hollow inner tube adapted to rotate to expel the mandrel through the motor into a repository.

A further aspect of the present invention includes the hollow inner tube passing through the retraction assembly and the motor to transfer the mandrel through the tool body into the repository.

A further aspect of the present invention includes retraction assembly being biased toward a neutral position by a spring positioned between the motor and the retraction assembly.

A further aspect of the present invention includes the retraction assembly being operated by air over hydraulics configuration.

A further aspect of the present invention includes ridges and/or grooves extending spirally within the hollow drive shaft or hollow inner tube to promote transfer of the mandrel.

### BRIEF DESCRIPTION OF THE DRAWINGS

The numerous advantages of the present invention may be better understood by those skilled in the art by reference to the accompanying figures in which:

FIG. 1 is a cross-sectional side elevation view of a riveting assembly including a motor assembly having a hollow drive shaft in accordance with an exemplary embodiment of the present invention;

FIG. 2A is a cross-sectional view of one exemplary embodiment of the motor assembly taken along line 2A-2A in FIG. 1; and

FIG. 2B is a cross-sectional view of another exemplary embodiment of the motor assembly shown in FIG. 2A.

### DETAILED DESCRIPTION OF THE INVENTION

Reference will now be made in detail to the presently preferred embodiments of the invention, examples of which are illustrated in the accompanying drawings.

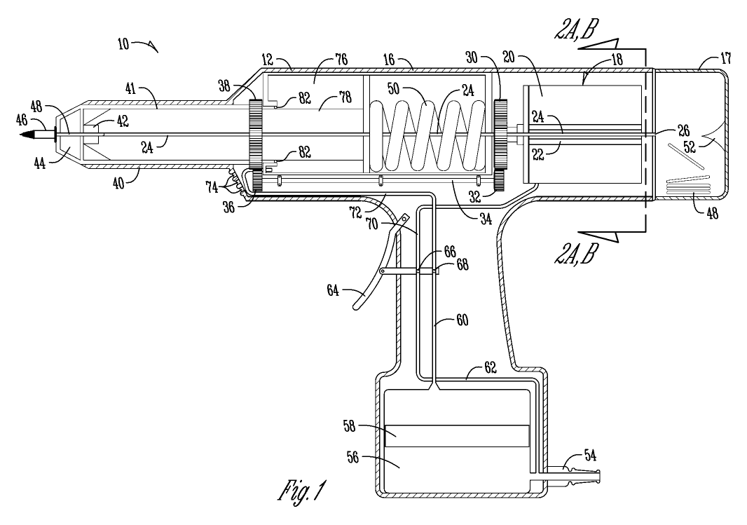

Referring generally to FIG. 1, a motor assembly 18 is described in accordance with exemplary embodiments of the present invention. The motor assembly 18 includes a hollow drive shaft 22. In a specific embodiment, the motor assembly may comprise a pneumatic motor 20 included with a riveting assembly 46. In embodiments where the riveting assembly 46 is for self-tapping rivets, the riveting assembly includes a repository 17 for receiving spent mandrels 48. In one specific embodiment, the repository 17 is co-axial with the hollow drive shaft 22 of the motor 20 to allow for direct feed of spent mandrels 48 from the self-tapping rivets through the hollow drive shaft 22 and into the repository 17. In another exemplary embodiment of the present invention, the motor 20 may have a hollow drive shaft 22 with or without grooves 84 for expelling spent portions of fixturing hardware or other materials through the motor wherein the motor may be further adapted for use in any inline device.

In the specific embodiment illustrated in the FIG. 1, the motor assembly 18 comprises a motor 20, adapted for use within hand tool 10. Descriptions herein are merely exemplary as hand tool 10 may be any conventional inline device, whether handheld or not handheld, where motor 20 imparts movement to a working end of the inline device, such as a drill, rivet gun, nail gun, or any inline device where a benefit would be derived from passing materials, whether in solid or liquid form, through the motor 20. For example, the inline device may be a device where expendable or residuary portions are transferred through the motor 20, where spiraled grooves and/or raised spiraled ridges, rotated with respect to or by the motor, may be used to transfer, pass or draw materials through the motor 20. In another embodiment, materials, whether solid or liquid, may be passed through the hollow drive shaft 22 to thereby drive the motor 20 using grooves inset within or raised spiral ridges on the inner circumference of the hollow drive shaft 22. For example, water may be forced through the hollow drive shaft 22 or hollow inner tube 20 to impart rotational motion to the motor 20 by way of the grooves or ridges extending along the inner circumference.

In another embodiment, the hand tool 10 may have a handle 14 for gripping as is customary with most hand tools. Alternatively, the hand tool 10 may be a mountable or stationary tool. Attached to handle 14 is a motor/drive casing 16 adapted to house motor 20 and hollow drive shaft 22. The motor/drive casing 16 affords protection to the “guts” of the hand tool 10 as can be appreciated by those skilled in the art of hand tool design. In the preferred embodiment of the present invention, the motor assembly 18 would be positioned and protected within a motor/drive casing, such as the motor/drive casing 16 of hand tool 10. It should also be appreciated that the motor 20 may be positioned anywhere within the motor/drive casing 16, whether near the working end or back end. Similarly, the motor 20 may also be used without the motor/drive casing 16.

The motor assembly 18 has a motor 20. Motor 20 may be electrically, pneumatically, hydraulically or hydro driven. In the preferred embodiment, motor 20 is pneumatically driven.

An exemplary embodiment for pneumatically driving motor 20 can be appreciated from the illustration in FIG. 1. For example, compressed air may be introduced into handle 14 through air input 54 as is customary with pneumatically driven hand tools. An air feed tube 62 may be connected to air input 54 for communicating compressed air to trigger 64. Trigger 64 may be single or double staged to operate a single function or multiple functions associated with the hand tool 10. For example, compressed air may be introduced into motor air feed tube 70, if trigger 64 is moved to a first stage position 66. Motor air feed tube 70 may be connected to the motor 20 for pneumatically driving motor 20 and impart rotation to hollow drive shaft 22. The motor/drive casing 16 may be vented to permit pressurized air, discharged from the motor 20, to be released from motor/drive casing 16 into the atmosphere. For example, motor/drive casing 16 may be fitted with air vent 74 to facilitate discharge of pressurized air from the hand tool 10 into the surrounding atmosphere.

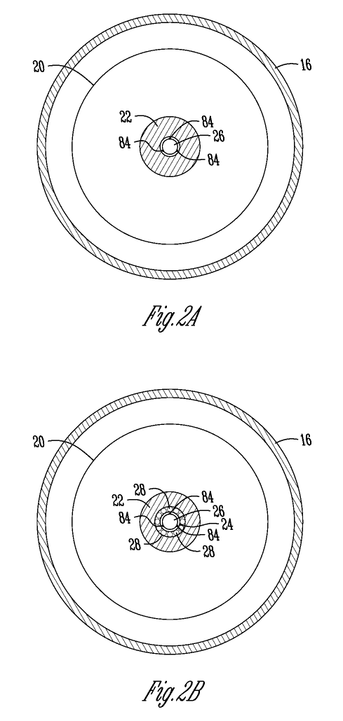

Although motor 20 may be pneumatically, hydraulically, electrically or hydro driven, it should be appreciated that movement, including rotational or otherwise, may be imparted from motor 20 to hollow drive shaft 22 by means known by those skilled in the art of motor design. In the present invention, it is preferred hollow drive shaft 22 extend through the motor 20 and be constructed of a suitable material of appropriate wall thickness to withstand forces acting on or applied to the hollow drive shaft 22, whether in torsion, compression or tension. As it is customary for drive shafts to extend through the center of pneumatically driven motors, it is preferred in the present invention that hollow drive shaft 22 extend through the center of motor 20. In one exemplary embodiment of the present invention, hollow drive shaft 22 may pass through motor 20 and provide a conduit 26 through motor 20 (See FIG. 2A) wherein spent portions of fixturing hardware, such as spent mandrels 48, my pass through to be ejected from the hand tool 10 or captured within repository 17 for subsequent disposal or recycling. In an alternative embodiment, a stationary or rotational, hollow, inner tube 24 may be disposed within hollow drive shaft 22 such that hollow inner tube 24 passes through motor 20 inside of hollow drive shaft 22. It can be appreciated that hollow inner tube 24 may extend forward and/or rearward of motor 20 whether within hollow drive shaft 22 or alone. In the preferred form, hollow inner tube 24 may be stationary with respect to motor 20 and hollow drive shaft 22 is rotatably supported about hollow inner tube 24 by bearings disposed between hollow inner tube 24 and hollow drive shaft 22. In another preferred form, the hollow inner tube 24 may be rotatably supported within the motor 20 and have spirally extending grooves 84 inset within the inner circumference of the hollow inner tube 24 to expel spent portions from through the motor 20. In another embodiment, spent portions may be expelled from the hollow inner tube 24 or hollow drive shaft 22 by vacuum. If the hollow inner tube 24 is stationary, needle or runner bearings 28 may be disposed between hollow inner tube 24 and hollow drive shaft 22 to support rotation of hollow drive shaft 22 while hollow inner tube 24 remains stationary with respect to motor 20 as best illustrated in FIG. 2B. To facilitate transfer of spent portions of fixturing hardware, such as spent mandrels 48, it is preferred that hollow inner tube 24 extend from the working end of the hand tool 10, through motor 20 and into repository 17. Similar to hollow drive shaft 22, hollow inner tube 24 forms conduit 26 extending through the length of hollow inner tube 24 to facilitate transfer of spent portions from the working end of hand tool 10, through motor 20 and into repository 17. As previously discussed, hollow inner tube 24 may also have grooves 84 spirally extending along the inner circumferential length of hollow inner tube 24 to promote transfer of spent portions through hollow inner tube 24 when the tube 24 is rotated to facilitate transfer of spent portions in zero-gravity environments.

In another exemplary embodiment of the present invention, hollow drive shaft 22 of motor 20 may be attached to drive gear 30. Drive gear 30 may be attached to hollow drive shaft 22 adjacent motor 20 or some other position within motor/drive casing 16. In one embodiment of the present invention, hollow drive shaft 22 may extend through drive gear 30 or terminate at drive gear 30. In another embodiment, hollow inner tube 24 extends through drive gear 30 within hollow drive shaft 22 or alone. Drive gear 30 may be adapted to mesh with driven gear 32. To facilitate gearing considerations and torque between motor 20 and the working end of the hand tool 10, both or either drive gear 30 and driven gear 32 may be a reduction gear, such as a planetary gear. A transfer drive shaft 34 is attached to driven gear 32 by meshing drive gear 30 with driven gear 32. Like earlier shafts 30, 32, drive gear 36 is attached to transfer drive shaft 34, which in-turn meshes with driven gear 38 adapted to impart rotation to outer drive 40. Both drive gear 36 and driven gear 38 may be a reduction gear, such as a planetary gear, to allow for variability in the rotational velocity and torque of outer drive 40 as is customary with most hand tools. Rotation imparted to outer drive 40 is transferred to clutch 44. Clutch 44 may be a keyed or keyless drill chuck as are well known. Clutch 44 grips fixturing hardware to impart motion, rotational or otherwise, to the fixturing hardware, such as a riveting assembly, etc.

In an embodiment where the motor assembly 18 has a hollow drive shaft 22 to facilitate the transfer of spent mandrels 48 from clutch 44, through conduit 26 and hollow drive shaft 22 into repository 17, a retraction assembly 41 may be integrated into the hand tool 10. For example, the retraction assembly 41 may have a grip 42 adapted to grip the spent mandrel portion 48 of the riveting assembly 46. Gripping dynamics of grip 42 could be such that movement of the retraction assembly 41, longitudinal, rotational or otherwise, may induce clamping in grip 42 to grip an expendable portion of the fixturing hardware, such as the mandrel portion that detaches from the riveting assembly 46 and becomes spent mandrel 48. The retraction assembly 41 may be pneumatically, hydraulically, electrically or hydro driven. FIG. 1 shows a retraction assembly 41 driven by air over hydraulics. For example, handle 14 may be fitted with air input 54, as previously discussed. Handle 14 may also be adapted to house an air over hydraulic piston/cylinder arrangement. As an example, cylinder 56 may be formed within handle 14 and adapted to reciprocally house piston 58. An air reservoir may exist on the downside of piston 58 and a hydraulic fluid reservoir on the upside of piston 58. Compressed air from air input 54 expands the air reservoir and drives piston 58 to drive hydraulic fluid from the hydraulic fluid reservoir into hydraulic fluid feed tube 60. Hydraulic fluid feed tube 60 communicates hydraulic fluid to trigger 64. As previously discussed, trigger 64 may be single or double staged to operate a single function or multiple functions associated with hand tool 10. For example, hydraulic fluid may be introduced into retraction assembly hydraulic feed tube 72, if trigger 64 is moved to a second stage position 68. Retraction assembly hydraulic feed tube 72 may be connected to the hydraulic cylinder 76 formed by cylinder walls 80 within the motor/drive casing 16 of the hand tool 10 for hydraulically driving hydraulic piston 78. Hydraulic piston 78 imparts movement, longitudinal, rotational or otherwise, to retraction assembly 41. As is customary with cylinder/piston arrangements, a gasket 82 may be disposed between cylinder walls 80 and hydraulic piston 78. Retraction assembly 41 may be biased toward a neutral position by spring 50. Additionally, retraction assembly 41 may be configured so that spring 50 causes grip 42 to clamp down on an expendable portion of any fixturing hardware used in conjunction with the hand tool 10, such as spent mandrel 48 of the riveting assembly 46. In another embodiment of the present invention, retraction assembly 41 may be disposed within outer drive 40 so that retraction assembly 41 may be retracted within outer drive 40 yet still permit outer drive 40 to impart movement to clutch 44. For example, clutch 44 may be adapted to grip and impart rotation to riveting assembly 46 and retraction assembly 41 may be adapted to grip and retract an expendable portion of the riveting assembly 46, such as spent mandrel 48. Inner tube 24 transports spent mandrel 48, upon detachment from the riveting assembly 46, from clutch 44, through conduit 26 within inner tube 24, through hollow drive shaft 22 within motor 20, and into repository 17. Repository 17 may be fitted with a deflector member 52 to direct movement of spent mandrels 48 into a resting position within the repository 17.

In an additional embodiment of the present invention, hollow drive shaft 22, alone, may extend forward from motor 20 to drive either or both the outer drive 40 and retraction assembly 41. Hollow drive shaft 22 may be configured with grooves 84, helical or otherwise, to promote transfer of spent mandrels 48, released from grip 42, through hollow drive shaft 22 into repository 17.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A motor assembly adapted for use in an inline device, the motor assembly comprising:
a motor adapted to impart movement to operate the inline device; and
a hollow drive shaft of the motor adapted to pass through the motor to provide a conduit through which an expendable portion of some fixturing hardware used with the inline device passes through to eject from or collect within the inline device.

2. The motor assembly of claim 1 wherein the motor may be pneumatically, electrically, hydraulically or hydro driven.

3. The motor assembly of claim 1 wherein the hollow drive shaft may surround a hollow inner tube adapted to expel the expendable portion of some fixturing hardware through the motor.

4. The motor assembly of claim 3 wherein needle bearings or other bearings adapted to support rotation are disposed between the hollow inner tube and the hollow drive shaft to rotatably support the hollow drive shaft.

5. The motor assembly of claim 1 wherein a plurality of grooves extend spirally along an inner circumference of the hollow drive shaft to promote transfer of the expendable portion of some fixturing hardware through the motor.

6. The motor assembly of claim 1 wherein the expendable portion of some fixturing hardware may be a shank of a self-tapping rivet.

7. The motor assembly of claim 1 further comprising a repository adapted to receive and collect the expendable portion of some fixturing hardware passed through the motor.

8. The motor assembly of claim 7 wherein the repository is co-axial with the hollow drive shaft of the motor to facilitate transfer of the expendable portion of some fixturing hardware through the motor.

9. The motor assembly of claim 8 wherein the repository has a deflector member adapted to direct travel of the expendable portion of some fixturing hardware expelled from the motor into the repository.

10. The motor assembly of claim 3 wherein a plurality of grooves extend spirally along an inner circumference of the hollow inner tube to promote transfer of the expendable portion of some fixturing hardware through the motor.

11. The motor assembly of claim 10 wherein the hollow inner tube is rotated with respect to the inline device to promote transfer of the expendable portion of some fixturing hardware through the motor.

12. The motor assembly of claim 1 wherein vacuum is used to promote transfer of the expendable portion of some fixturing hardware through the motor.

13. The motor assembly of claim 1 wherein a plurality of ridges extend spirally along an inner circumference of the hollow drive shaft to promote transfer of the expendable portion of some fixturing hardware through the motor.

14. A motor assembly adapted for use in an inline device, the motor assembly comprising:
a motor having a hollow drive shaft adapted to pass through the motor and impart movement to operate the inline device; and
a hollow inner tube within the hollow drive shaft adapted to provide a conduit through the motor wherein spent portions of fixturing hardware used with the inline device pass through to eject from or collect within a repository.

15. The motor assembly of claim 14 wherein the hollow inner tube may be stationary or rotational with respect to the inline device.

16. The motor assembly of claim 14 wherein the hollow drive shaft rotates around the hollow inner tube to impart movement to operate the inline device.

17. The motor assembly of claim 14 wherein needle bearings or other bearings adapted to support rotation are disposed between the hollow inner tube and the hollow drive shaft to rotatably support the hollow drive shaft and/or hollow inner tube.

18. The motor assembly of claim 17 wherein a plurality of grooves extend spirally along an inner circumference of the hollow inner tube to promote transfer of spent portions through the motor upon rotation into the repository.

19. A motor assembly adapted for use in an inline device to set a self-tapping rivet, the motor assembly comprising:
a motor having a hollow drive shaft adapted to pass through the motor and impart movement to a mandrel of the self-tapping rivet relative to the inline device; and
a conduit within the hollow drive shaft wherein the conduit is inline with the motor and adapted to transfer the mandrel from one end of the inline device, through the motor and into a repository upon detachment of the shank from the self-tapping rivet.

20. The motor assembly of claim 19 wherein the conduit may be a stationary hollow inner tube or a rotational hollow inner tube separate from the hollow drive shaft.

21. The motor assembly of claim 20 wherein needle bearings or other bearings adapted to support rotation are disposed between the stationary hollow inner tube and/or rotational hollow inner tube and the hollow drive shaft to rotatably support the hollow drive shaft.

22. The motor assembly of claim 19 wherein the motor is pneumatically driven.

23. The motor assembly of claim 19 wherein a plurality of grooves extend spirally along an inner circumference of the conduit to promote transfer of the shank through the conduit and motor into the repository.

24. The motor assembly of claim 23 wherein the plurality of grooves expel the shank in a zero-gravity environment.

25. A rivet setting tool having a motor assembly adapted to pass a mandrel of a self-tapping rivet there through, the rivet setting tool comprising:
a tool body;
an outer drive having a clutch adapted to grip and rotate the self-tapping rivet with respect to the tool body;
a motor within the tool body having a hollow drive shaft, wherein the hollow drive shaft is configured to impart rotation to the outer drive;
a retraction assembly having a grip adapted to retract the mandrel, the retraction assembly operating separately from the outer drive to detach the mandrel from the self-tapping rivet; and
the hollow drive shaft of the motor adapted to pass through the motor to provide a conduit which the mandrel passes through to eject from or collect within the tool body.

26. The rivet setting tool of claim 25 wherein the hollow drive shaft surrounds a hollow inner tube adapted to rotate to expel the mandrel through the motor into a repository.

27. The rivet setting tool of claim 26 wherein the hollow inner tube passes through the retraction assembly and the motor to transfer the mandrel through the tool body into the repository.

28. The rivet setting tool of claim 25 wherein the retraction assembly is biased toward a neutral position by a spring positioned between the motor and the retraction assembly.

29. The rivet setting tool of claim 25 wherein the retraction assembly is operated by air over hydraulics configuration.

30. The rivet setting tool of claim 26 wherein ridges and/or grooves extending spirally within the hollow drive shaft or hollow inner tube to promote transfer of the mandrel.
